(19) United States
(12) Patent Application Publication
(10) Pub. No.: US 2015/0195638 A1
(43) Pub. Date: Jul. 9, 2015

(54) IN-EAR EARPHONE

(71) Applicant: Cheng Uei Precision Industry Co., Ltd., New Taipei City (TW)

(72) Inventor: Mu Tsun Tseng, New Taipei City (TW)

(73) Assignee: Cheng Uei Precision Industry Co., Ltd., New Taipei City (TW)

(21) Appl. No.: 14/147,198

(22) Filed: Jan. 3, 2014

(51) Int. Cl. H04R 1/10

(52) U.S. Cl. CPC H04R 1/1058; H04R 1/1016

(57) ABSTRACT

An in-ear earphone includes an earcap, a loudspeaker module and a rear housing. The earcap has a hollow cap portion, and a front housing integrally molded to a front of an inside surface of the cap portion. The cap portion defines a sound hole. The front housing includes a hollow connecting tube protruded rearward from the front of the inside surface of the cap portion and projecting inside of the cap portion, and a hollow sleeve spread outward and then extended rearward from a free end of the connecting tube. The sleeve defines an accommodating space of which one end is communicated with an inside of the hollow connecting tube and the other end is communicated with an outside. The loudspeaker module is accommodated in the accommodating space of the sleeve. The rear housing is covered to a rear of the sleeve of the earcap.

### BACKGROUND OF THE INVENTION

1. Field of the Invention

The present invention generally relates to an earphone, and more particularly to an in-ear earphone.

2. the Related Art

Referring to FIG. 5, a conventional in-ear earphone 100′ includes an earcap 10′, a front housing 20′, a loudspeaker 30′, a rear housing 40′ and a hand shank 50′. The earcap 10′ includes a cap portion 11′ of hollow semi-circle shape, and a hollow first connecting tube 12′ protruded rearward from a front inner periphery of the cap portion 11′ and spaced from a rear inner periphery of the cap portion 11′. The front housing 20′ has a hollow sound tube 21′, a sealing cover 22′ spread outward from an outer periphery of a rear end of the sound tube 21′, and a sealing barrel 23′ extended rearward from an outer periphery of the sealing cover 22′. A periphery of a rear surface of the sealing barrel 23′ protrudes rearward to form a ring-shaped supporting wall 24′ connecting with a rear periphery of the sealing cover 22′. An outer periphery of the sound tube 21′ is spread outward to form a second connecting tube 211′. The rear housing 40′ has a rear wall 41′, a blocking wall 42′ surrounding a periphery of the rear wall 41′, a ring-shaped connecting wall 43′ connected with a front periphery of the blocking wall 42′, and an inserting wall 44′ protruded forward from an inner periphery of the connecting wall 43′. A bottom of the blocking wall 42′ defines an assembling hole 421′. The hand shank 50′ has an arc-shaped assembling portion 51′ and an insertion portion 52′ extended downward from a bottom of the assembling portion 51′.

When the earphone 100′ is assembled, the loudspeaker 30′ is assembled forward to the front housing 20′ with a front periphery of the loudspeaker 30′ resisting against an inner periphery of a rear of the supporting wall 24′. Then the rear housing 40′ is assembled forward to the front housing 20′ with the inserting wall 44′ being attached to a rear inner periphery of the sealed barrel 23′ and resisting against an outer periphery of the rear of the supporting wall 24′ for locating the loudspeaker 30′ between the front housing 20′ and the rear housing 40′. Accordingly, a sound cavity (not shown) is formed among the front housing 20′, the rear housing 40′ and the loudspeaker 30′. The earcap 10′ is assembled rearward to the front housing 20′ with the first connecting tube 12′ being connected with the second connecting tube 211′ and a rear surface of the cap portion 11′ abutting against a front periphery of the sealing cover 22′. The assembling portion 51′ of the hand shank 50′ is assembled to the assembling hole 421′.

However, the conventional in-ear earphone 100′ includes more mechanical components that results in a complex assembling procedure to waste working time. Therefore, a manufacturing cost of the in-ear earphone 100′ is higher and an assembling yield is lower.

### SUMMARY OF THE INVENTION

An object of the present invention is to provide an in-ear earphone. The in-ear earphone includes an earcap, a loudspeaker module and a rear housing. The earcap has a hollow cap portion, and a front housing integrally molded to a front of an inside surface of the cap portion. The cap portion defines a sound hole. The front housing includes a hollow connecting tube protruded rearward from the front of the inside surface of the cap portion and projecting inside of the cap portion, and a hollow sleeve spread outward and then extended rearward from a free end of the connecting tube. The sleeve defines an accommodating space of which one end is communicated with an inside of the hollow connecting tube and the other end is communicated with an outside. The loudspeaker module is accommodated in the accommodating space of the sleeve. The rear housing is covered to a rear of the sleeve of the earcap.

As described above, the in-ear earphone includes the earcap, the loudspeaker module and the rear housing, the front housing includes the hollow connecting tube, and the hollow sleeve spread outward and then extended rearward from a free end of the connecting tube, and the loudspeaker module is accommodated in the accommodating space of the sleeve directly. Thus, the loudspeaker module is closer to the cap portion for improving the sound quality of the in-ear earphone, and the in-ear earphone has less mechanical components to make the in-ear earphone have the light volume, the lower cost and the higher assembly yield.

### BRIEF DESCRIPTION OF THE DRAWINGS

The present invention will be apparent to those skilled in the art by reading the following description, with reference to the attached drawings, in which:

FIG. 1 is a perspective view of an in-ear earphone in accordance with an embodiment of the present invention;

FIG. 2 is an exploded view of the in-ear earphone of FIG. 1;

FIG. 3 is another exploded view of the in-ear earphone of FIG. 1;

FIG. 4 is a partially sectional view of the in-ear earphone of FIG. 1; and

FIG. 5 is an exploded view of an in-ear earphone in prior art.

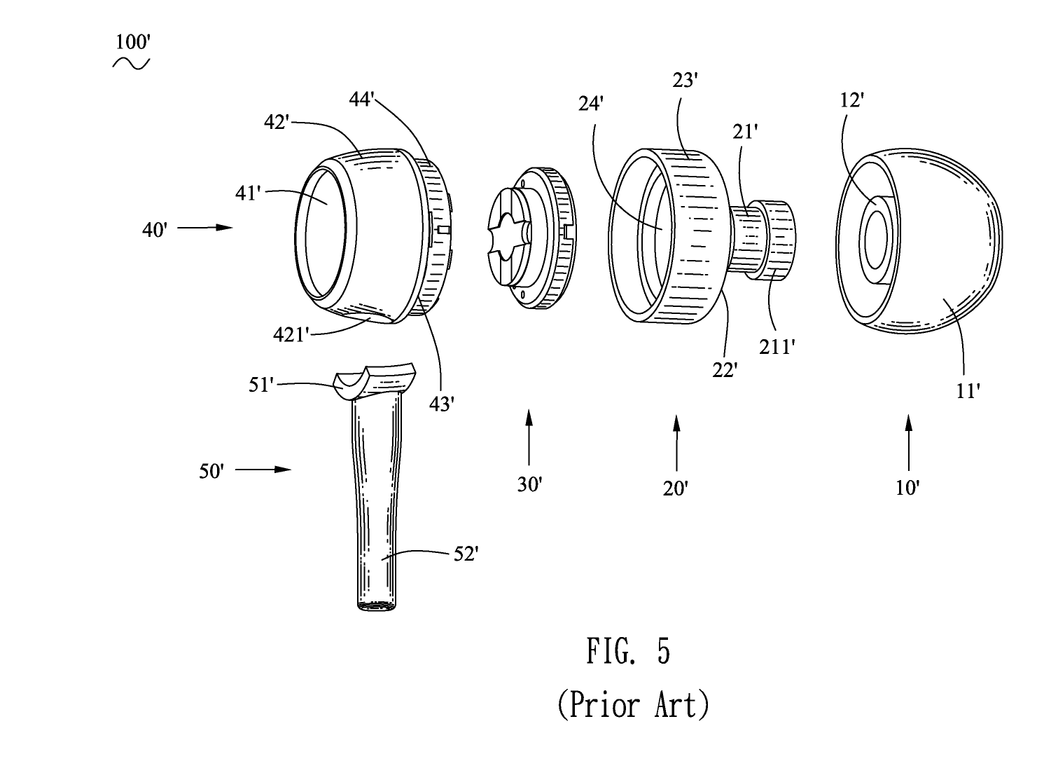

### DETAILED DESCRIPTION OF THE PREFERRED EMBODIMENT

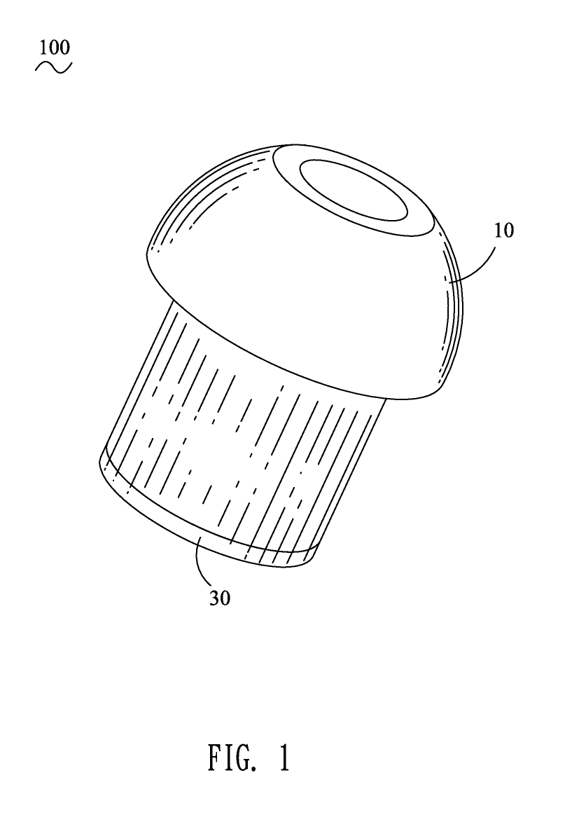

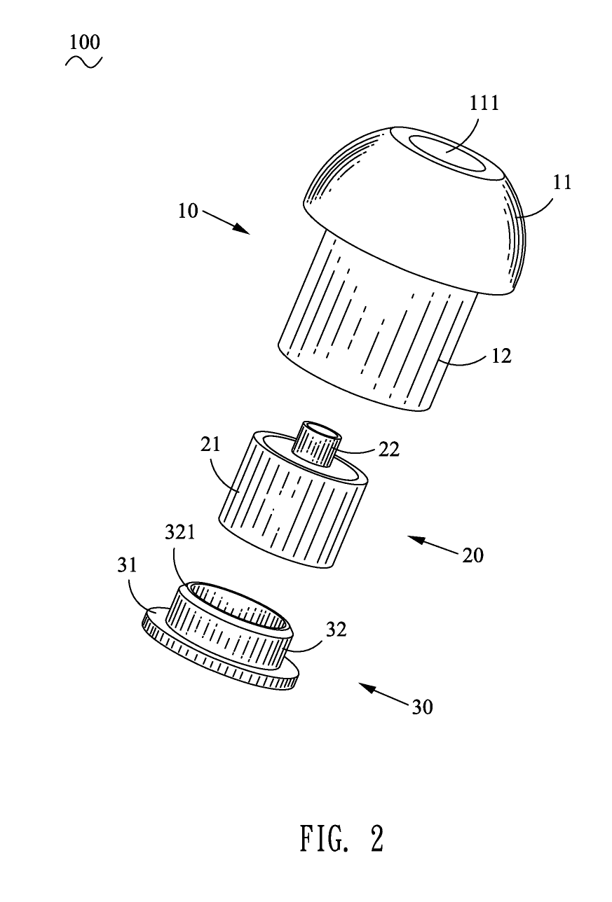

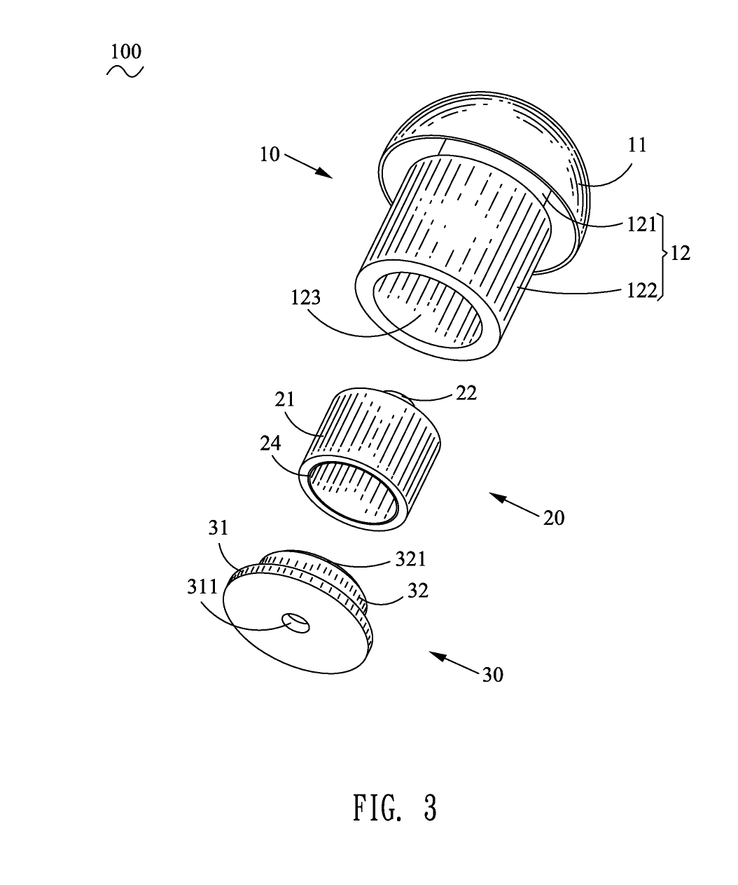

With reference to FIG. 1, FIG. 2 and FIG. 3, an in-ear earphone 100 in accordance with an embodiment of the present invention is shown. The in-ear earphone 100 includes an earcap 10, a loudspeaker module 20 and a rear housing 30.

Referring to FIGS. 1-3, the earcap 10 has a hemispherical hollow cap portion 11, and a front housing 12 integrally molded to a front of an inside surface of the cap portion 11. The cap portion 11 defines a sound hole 111 penetrating therethrough. The front housing 12 includes a hollow connecting tube 121 protruded rearward from the front of the inside surface of the cap portion 11 and projecting inside of the cap portion 11, and a hollow sleeve 122 spread outward and then extended rearward from a free end of the connecting tube 121. A middle of the sleeve 122 defines an accommodating space 123 of which one end is communicated with an inside of the hollow connecting tube 121 and the other end is communicated with an outside.

Referring to FIGS. 2-4, the loudspeaker module 20 has a base body 21, a hollow cylindrical sound element 22 connected with a front surface of the base body 21, and a horn monomer 23 assembled to the base body 21. A rear surface of the base body 21 is recessed inward to form a ring-shaped recess 24. The loudspeaker module 20 is accommodated in the accommodating space 123 of the sleeve 122.

Referring to FIG. 2 and FIG. 3, the rear housing 30 has a circular base plate 31. A rear of the base plate 31 defines an outlet hole 311. A middle of a front surface of the base plate 31 protrudes forward to form a hollow cylindrical ring-shaped clamping portion 32.

Referring to FIG. 2 and FIG. 3, a front end of the clamping portion 32 protrudes forward to form a pyramid portion 321 of pyramid shape, when the clamping portion 32 is snapped in a rear end of the accommodating space 123 of the sleeve 122, the pyramid portion 321 abuts against the rear surface of the base body 21 of the loudspeaker module 20.

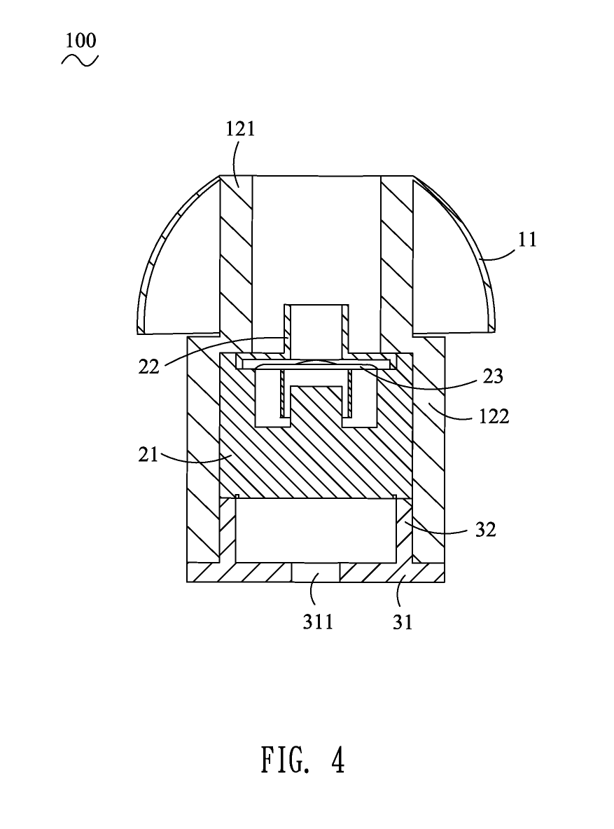

Referring to FIG. 3 and FIG. 4, when the in-ear earphone 100 is assembled, the loudspeaker module 20 is accommodated in the accommodating space 123 of the sleeve 122 directly. The front surface of the base body 21 of the loudspeaker module 20 abuts against a rear surface of the connecting tube 121 of the earcap 10, and the sound element 22 projects inside of the hollow connecting tube 121. So that, the loudspeaker module 20 is closer to the cap portion 11 for improving a sound quality of the in-ear earphone 100. The rear housing 30 is covered to a rear of the sleeve 122 of the earcap 10. The clamping portion 32 is snapped in the rear end of the accommodating space 123 of the sleeve 122. The pyramid portion 321 abuts against the rear surface of the base body 21 of the loudspeaker module 20 for fastening the loudspeaker module 20 to the earcap 10.

In this embodiment, the earcap 10 is made of rubber material, so when the loudspeaker module 20 is accommodated in the accommodating space 123 of the sleeve 122, and the rear housing 30 is covered to the rear of the sleeve 122 of the earcap 10, the loudspeaker module 20 and the clamping portion 32 of the rear housing 30 is able to be enclosed firmly in the sleeve 122 of the earcap 10.

As described above, the in-ear earphone 100 includes the earcap 10, the loudspeaker module 20 and the rear housing 30, the front housing 12 includes the hollow connecting tube 121, and the hollow sleeve 122 spread outward and then extended rearward from the free end of the connecting tube 121, and the loudspeaker module 20 is accommodated in the accommodating space 123 of the sleeve 122 directly. Thus, the loudspeaker module 20 is closer to the cap portion 11 for improving the sound quality of the in-ear earphone 100, and the in-ear earphone 100 has less mechanical components to make the in-ear earphone 100 have a light volume, a lower cost and a higher assembly yield.

What is claimed is:

1. An in-ear earphone, comprising:
an earcap having a hollow cap portion, and a front housing integrally molded to a front of an inside surface of the cap portion, the cap portion defining a sound hole, the front housing including a hollow connecting tube protruded rearward from the front of the inside surface of the cap portion and projecting inside of the cap portion, and a hollow sleeve spread outward and then extended rearward from a free end of the connecting tube, the sleeve defining an accommodating space of which one end is communicated with an inside of the hollow connecting tube and the other end is communicated with an outside;
a loudspeaker module being accommodated in the accommodating space of the sleeve; and
a rear housing covered to a rear of the sleeve of the earcap.

2. The in-ear earphone as claimed in claim 1, wherein the loudspeaker module has a base body, a hollow cylindrical sound element connected with a front surface of the base body, and a horn monomer assembled to the base body, a front surface of the base body of the loudspeaker module abuts against a rear surface of the connecting tube of the earcap, and the sound element projects inside of the hollow connecting tube.

3. The in-ear earphone as claimed in claim 1, wherein the loudspeaker module has a base body, and a horn monomer assembled to the base body.

4. The in-ear earphone as claimed in claim 1, wherein the rear housing has a circular base plate, a front surface of the base plate protrudes forward to form a hollow cylindrical ring-shaped clamping portion, the clamping portion is snapped in a rear end of the accommodating space of the sleeve.

5. The in-ear earphone as claimed in claim 4, wherein a rear of the base plate of the rear housing defines an outlet hole.

6. The in-ear earphone as claimed in claim 4, wherein a front end of the clamping portion protrudes forward to form a pyramid portion of pyramid shape, when the clamping portion is snapped in the rear end of the accommodating space of the sleeve, the pyramid portion abuts against the rear surface of the base body of the loudspeaker module.

7. The in-ear earphone as claimed in claim 1, wherein the earcap is made of rubber material.
